(19) United States
(12) Patent Application Publication
(10) Pub. No.: US 2024/0079765 A1
(43) Pub. Date: Mar. 7, 2024

(54) ANTENNA, WIRELESS SIGNAL PROCESSING DEVICE, AND UNMANNED AERIAL VEHICLE

(71) Applicant: AUTEL ROBOTICS CO., LTD., Shenzhen (CN)

(72) Inventors: Jianping SONG, Shenzhen (CN); Jianlei WANG, Shenzhen (CN)

(73) Assignee: AUTEL ROBOTICS CO., LTD., Shenzhen (CN)

(21) Appl. No.: 18/367,458

(22) Filed: Sep. 12, 2023

(30) Foreign Application Priority Data
Mar. 12, 2021 (CN) 2021102723378

(51) Int. Cl. H01Q 1/38; H01Q 1/28; H01Q 5/307

(52) U.S. Cl. CPC H01Q 1/38; H01Q 1/28; H01Q 5/307

(57) ABSTRACT

The present disclosure provides an antenna, a wireless signal processing device, and an unmanned aerial vehicle. The antenna includes: a substrate having a flat first surface; a first radiation portion disposed on the first surface of the substrate, the first radiation portion comprising a first radiator and a second radiator, and the second radiator being located behind the first radiator; and a second radiation portion disposed on the first surface of the substrate. The second radiation portion includes: a third radiator; and the third radiator being disposed proximate to the second radiator and having a proximate frequency and radiator arm effective length to couple the third radiator with the second radiator. The antenna adopts reasonable wiring and structural design and can be implemented on a base material with a small volume.

### CROSS REFERENCE TO RELATED DISCLOSURE

This application is a Continuation application of International Application No. PCT/CN2022/079353, filed on Mar. 4, 2022, which claims the benefit of priority to the Chinese patent application 202110272337.8 filed on Mar. 12, 2021, the entire disclosures of which are incorporated herein by references for all purposes.

### BACKGROUND

An antenna is a key component for transmitting and receiving electromagnetic wave wireless signals. Its performance has a significant impact on unmanned aerial vehicles and other devices that need long-range wireless data transmission. With the continuous development of society, more and more frequency bands are used in wireless transmission, and the demand for multi-frequency-band antennas is increasing.

In the case where the frequencies of multiple antenna frequency bands are relatively close, it is often necessary to use an antenna with a complicated structural design to meet the requirements of use. However, these antennas with complex structure designs are difficult to apply to small products such as unmanned aerial vehicles, remote controllers, etc. which are sensitive to sizes and structures.

### SUMMARY

The present disclosure relates to the technical field of antenna structures, in particular to an antenna, a wireless signal processing device, and an unmanned aerial vehicle.

The embodiments of the present disclosure are intended to provide an antenna, a wireless signal processing device, and an unmanned aerial vehicle, capable of overcoming the defects of the complex structure of the existing multi-band antenna.

According to a first aspect of the present disclosure; provide the following technical solutions: an antenna. The antenna comprises:
a substrate having a flat first surface;
a first radiation portion disposed on the first surface of the substrate, the first radiation portion comprising: a first radiator and a second radiator facing in opposite directions; and
a second radiation portion disposed on the first surface of the substrate, the second radiation portion comprising: a third radiator; where the third radiator and the second radiator are arranged close to each other and have a proximate frequency and radiator arm effective length, so that the third radiator and the second radiator are coupled with each other;
where the first radiator, the second radiator, and the third radiator are connected to form a feed line of a grounding point and a feed point.

According to a second aspect of the present disclosure, a wireless signal processing device. The wireless signal processing device comprises: the antenna for transmitting or receiving a wireless signal; and a receiving path for parsing the wireless signal received by the antenna to acquire the information content contained in the wireless signal; and a transmitting path for loading information content into a radio frequency carrier signal to form a wireless signal and send same via the antenna.

According to a third aspect of the present disclosure, an unmanned aerial vehicle. The unmanned aerial vehicle comprises: a fuselage having a foot stool and a propeller thereon; a motor mounted to the joint between the fuselage and the foot stool to provide flight power for the unmanned aerial vehicle; and the antenna mounted on the foot stool.

### BRIEF DESCRIPTION OF THE DRAWINGS

One or more embodiments are exemplified by drawings in the accompanying drawings corresponding to the embodiments. These exemplified descriptions do not constitute a limitation on the embodiments. Radiators in the drawings having the same reference number designations are illustrated as similar radiators, and unless otherwise particularly stated, the drawings do not constitute a proportional limitation.

FIG. 1 is a schematic diagram of a first surface of an antenna provided by one or more embodiments of the present disclosure;

FIG. 2 is a schematic diagram of a second surface of an antenna provided by one or more embodiments of the present disclosure;

FIG. 3 is a schematic diagram showing a structure of a first radiator provided by one or more embodiments of the present disclosure;

FIG. 4 is a schematic diagram of low and medium frequency band S parameters of an antenna provided by one or more embodiments of the present disclosure;

FIG. 5 is a schematic diagram of high frequency band S parameters of an antenna provided by one or more embodiments of the present disclosure;

FIG. 6 is a directional diagram of an antenna in a low frequency band provided by one or more embodiments of the present disclosure;

FIG. 7 is a directional diagram of an antenna in a medium frequency band provided by one or more embodiments of the present disclosure;

FIG. 8 is a directional diagram of an antenna in a high frequency band provided by one or more embodiments of the present disclosure;

FIG. 9 is a schematic diagram of a wireless signal processing device provided by one or more embodiments of the present disclosure; and

FIG. 10 is a schematic diagram of an antenna provided by one or more embodiments of the present disclosure in an unmanned aerial vehicle application scenario.

### DETAILED DESCRIPTION

In order to make the present disclosure readily understood, a more particular description of the disclosure will be rendered by reference to accompanying drawings and specific embodiments.

It is noted that the terms “first,” “second,” and the like in the specification, claims and the above-mentioned figures of this application are used for distinguishing between similar objects and not necessarily for describing a particular sequential or chronological order.

It needs to be noted that when a radiator is referred to as being “secured” to another radiator, it can be directly on another radiator or one or more intervening radiators may be present in between. When one radiator is referred to as being “connected” to another radiator, it can be directly connected to another radiator or one or more intervening radiators may be present in between. As used in the description, the orientations or positional relationships indicated by the terms “up”, “down”, “inner”, “outer”, “bottom” and the like are based on the orientations or positional relationships shown in the drawings for purposes of describing the disclosure and simplifying the description only, and are not intended to indicate or imply that the referenced device or radiator must have a particular orientation or be constructed and operated in a particular orientation. It is therefore not to be understood as limiting the disclosure. Furthermore, the terms “first”, “second”, “third” and the like are used for descriptive purposes only and are not to be construed as indicating or implying relative importance.

Unless defined otherwise, all technical and scientific terms used herein have the same meaning as commonly understood by one of ordinary skill in the art to which this disclosure belongs. The terminology used herein in the description of the present disclosure is for the purpose of describing particular embodiments only and is not to be limiting of the present disclosure. As used herein, the term “and/or” includes any and all combinations of one or more of the associated listed items.

Further, the technical features involved in different embodiments of the present disclosure described below can be combined with each other as long as they do not conflict with each other.

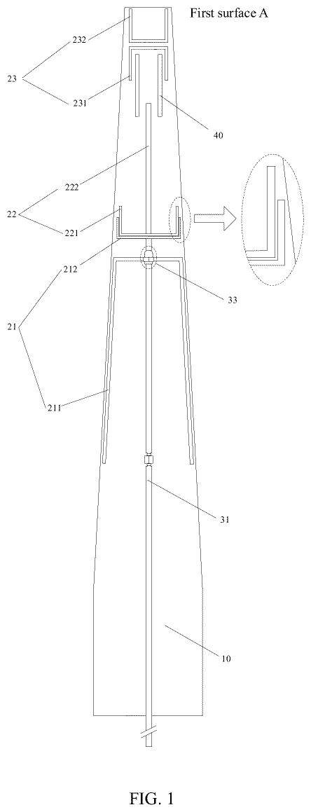

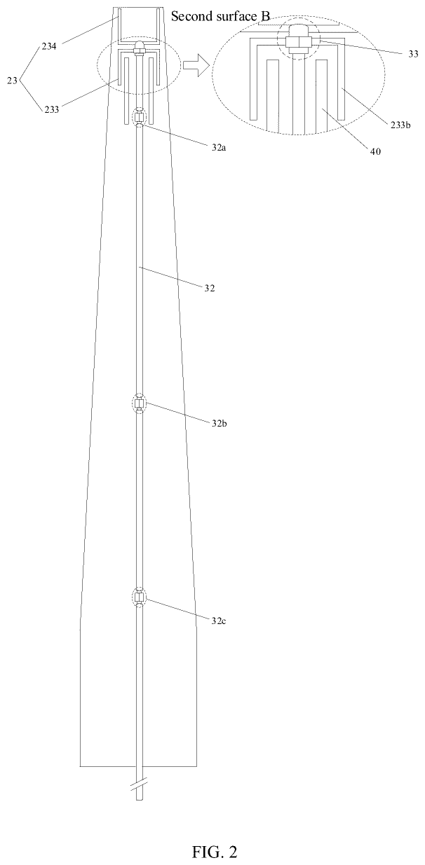

FIG. 1 is a schematic diagram showing a front-side structure of an antenna according to one or more embodiments of the present disclosure. FIG. 2 is a schematic diagram showing a reverse-side structure of an antenna according to one or more embodiments of the present disclosure. In the present embodiment, the front side of the antenna is referred to as a “first surface A” while the back side of the same is referred to as a “second surface B” for convenience of representation. The “first” and “second” are only used to distinguish the front side from the reverse side of a substrate 10 and are not used to define a surface.

As shown in FIGS. 1 and 2, the antenna mainly includes a substrate 10 as a base of an antenna structure, radiation portions (21, 22, 23) composed of a radiator having a specific structural shape and disposed on a first surface A and a second surface B of the substrate, and feed lines (31, 32) connected to the radiator to form feed point and grounding point. The radiator may also be referred to as vibrator or oscillator.

Among other things, the substrate 10 may be a non-conductive structure fabricated from any type of material (e.g., plastic, foam) and having a particular shape (e.g., a long rectangle). It has a relatively tabular shape, forming a flat first surface and second surface.

The “radiation portion” refers to a resonant unit for receiving or transmitting radio signals of a specific frequency band, and is the core of the whole antenna system. It may generally consist of one or more identical or different radiators having a particular shape or structure. These radiators can be a conductor fixed to the surface of substrate 10 in any suitable form (such as surface mount) with a specific length. It achieves the reception or transmission of wireless signals belonging to a particular frequency band through the principle of electromagnetic induction. In the present embodiment, the antenna may be provided with a total of three radiation portions including the first radiation portion 21, the second radiation portion 22, and the third radiation portion 23.

Each radiation portion corresponds to a radio signal of a different frequency band. The first radiation portion 21 may correspond to a low frequency signal, the second radiation portion 22 to a medium frequency signal, and the third radiation portion 23 to a high frequency signal (e.g., a 5G full frequency band).

In some embodiments, as shown in FIG. 1, the first radiation portion 21 includes a first radiator 211 and a second radiator 212, and the second radiation portion 22 includes a third radiator 221.

Here, the openings between the first radiator 211 and the second radiator 212 are oppositely oriented and are referred to as “rear radiator” and “front radiator”, respectively, in this embodiment.

Specifically, the opening of the first radiator 211 is oriented in the same direction as the extension direction of the feed line 31, while the opening of the second radiator 212 is oriented opposite to the extension direction of the feed line 31. As shown in FIG. 1, the second radiator 212 is located further away from the antenna root (i.e., the extension direction of the feed line) compared with the first radiator 211. The second radiator 212 belongs to the front region of the antenna. Therefore, the first radiator 211 may be referred to as a “rear radiator” and the second radiator 212 may be referred to as the “front radiator”.

The third radiator 221 is arranged close to the second radiator 212 and has a position close to each other. By “close to each other” it meant that the spacing between the second radiator 212 and the third radiator 221 on the substrate is less than a certain threshold or that the spacing between the two radiators is within a small range of values. The interval between the two can be specifically set and adjusted according to the requirements of actual situations.

The third radiator 221 and the second radiator 212 also have close frequencies and radiator arm effective lengths between them. “Close to” is similar to “close to each other” described above, and also means that the difference between the two is less than a certain threshold or within a small numerical range.

In this embodiment, the second radiator 212 and the third radiator 221 are located close to each other. The goal of having a close frequency and radiator arm effective length is to couple the second radiator with the third radiator.

Therefore, a person skilled in the art could adjust one or more of the position proximity degree, the frequency proximity degree, and the radiator arm effective length between the second radiator 212 and the third radiator 221 according to the requirements of actual situations so as to enable the second radiator 212 and the third radiator 221 to be coupled with each other. All the adjustments, changes, or substitutions made to the present application for realizing the mutual coupling of the second radiator 212 and the third radiator 221 fall within the scope of protection of the present application.

The antenna structure provided by the embodiments of the present disclosure can effectively enhance the coverage of a medium frequency signal and a low frequency signal by the mutual coupling of the second radiator and the third radiator, so as to meet the requirements of the medium frequency signal and the low frequency signal, especially in the case where the frequency bands of both the medium frequency signal and the low frequency signal are relatively close.

In some embodiments, as shown in FIG. 1, the first radiator 211, the second radiator 212, and the third radiator 221 may be axially symmetric structures. The “axisymmetric distribution” means a symmetrical distribution along the central axis of the substrate 10. In other words, the first radiator 211, the second radiator 212, and the third radiator 221 each have a left-right symmetric shape to ensure signal coverage for a specific frequency band.

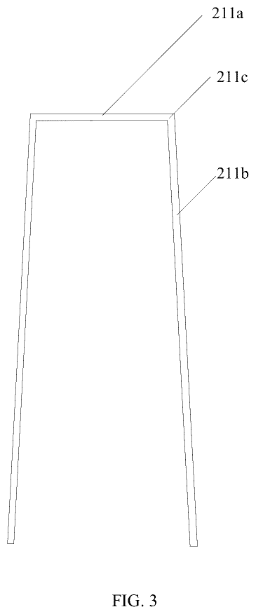

Specifically, both the first radiator 211 and the second radiator 212 may take the form of a “first radiator shape” structure. In order to fully explain the “first radiator shape”, the following detailed description is made with the first radiator shown in FIG. 3 as an example:

As shown in FIG. 3, the “first radiator shape” can be roughly considered to be composed of a radiator body 211a and a pair of radiator arms 211b. Among them, two tail ends of the radiator body 211a are bending portions 211c with a certain bending angle (such as 90° or a larger or smaller angle). The radiator arms 211b is formed by the bending portion 211c extending a predetermined length along a straight line or in another form (such as a serpentine shape), thereby forming a radiator shape similar to a “U” shape.

The predetermined length is determined according to the signal requirements of the radiation portion or the antenna, and can be set by a skilled person according to actual situations.

In other embodiments, the second radiation portion 22 may also include a microstrip line 222. The microstrip line 222 is combined with the third radiator 221 to form a shape structure different from the first radiator shape described above, which is referred to as a “second radiator shape” in the description, so as to satisfy the requirements of the medium frequency signal.

As shown in FIG. 1, the third radiator 221 may take on a radiator shape similar to the second radiator 212 (i.e., the first radiator shape). The two are close to each other and have the same opening orientation. In addition, the microstrip line 222 is in a straight line shape, and is arranged on an axis of symmetry of the third radiator 221 (namely, the central axis of the substrate 10), thereby forming, together with the third radiator 221, a second radiator shape which is different from the “first radiator shape” and resembles an epsilon-type shape.

In still other embodiments, the third radiation portion 23 corresponding to the high frequency signal may be symmetrically distributed on the first surface A and the second surface B of the substrate. That is, the third radiation portion 23 has an identical radiator structure form at the first surface A and the second surface B.

As shown in FIGS. 1 and 2, the third radiation portion 23 may be roughly divided into four parts of a fourth radiator 231, a fifth radiator 232, a sixth radiator 233, and a seventh radiator 234.

The fourth radiator 231 and the fifth radiator 232 are both arranged on the first surface A, and the two are in a mirror-symmetric relation, with opposite opening orientations. Similarly, the sixth radiator 233 and the seventh radiator 234 are arranged on the second surface B, also in a mirror-symmetric relationship, with opposite opening orientations.

Specifically, the fourth radiator 231, the fifth radiator 232, the sixth radiator 233, and the seventh radiator 234 may have the same axially symmetric structure as the first radiator 211, the second radiator 212, and the third radiator 221.

With regard to positions, the fourth radiator 231 is closer to the root of the substrate with respect to the fifth radiator 232, and the sixth radiator 233 is closer to the root of the substrate with respect to the seventh radiator 234 (namely, the fourth radiator 231 and the sixth radiator 233 extend in the same direction as the feed line). At that, the fifth radiator 232 and the seventh radiator 234 may be referred to as “front radiators”, and the fourth radiator 231 and the sixth radiator 233 may be referred to as “rear radiators”.

In some embodiments, the fourth radiator 231, the fifth radiator 232, the sixth radiator 233, and the seventh radiator 234 may adopt the “first radiator shape” described in the above embodiments, i.e., similar to the “U”-shaped radiator shape, to meet the use requirements of high-frequency signals.

In a preferred embodiment, the substrate 10 may also be provided with a clearance groove 40. The clearance groove 40 may be opened in pairs in a region where the third radiation portion 23 is located, for example, symmetrically arranged between two radiator arms of the sixth radiator 233 (or two radiator arms of the fourth radiator 231) of the third radiation portion.

As shown in FIG. 2, by additionally providing the clearance groove 40, the capacitance structure formed between two radiator arms 233b of the sixth radiator 233 can be improved, and the above-mentioned mutual coupling, and the interference of the second radiator and the third radiator for low and medium frequency signals on high-frequency signals can also be reduced.

The feed lines (31, 32) are signal transmitting paths connecting the “radiation portion” with other signal processing systems. The feed lines (31, 32) typically have good shielding and signal transmission performances to avoid undesirable interference on wireless signals received or transmitted by the “radiation portion” during the transmission. Specifically, any suitable type of wire may be used, such as a coaxial line.

As shown in FIGS. 1 and 2, the antenna provided in the present embodiment may be provided with a first feed line 31 and a second feed line 32 at a first surface A and a second surface B of the substrate 10, respectively, to provide an appropriate number of grounding points and feed points. For example, the second feed line 32 shown in FIG. 2 is grounded three times, and three different grounding points 32a, 32b, and 32c are provided.

In some embodiments, a coaxial line can be used as the feed line. The first radiator 211 of the first radiation portion 21 serving as a front radiator can be electrically connected to the inner conductor of the coaxial line, and the second radiator 212 serving as a rear radiator is electrically connected to the outer conductor of the coaxial line, so as to form one feed point and three grounding points, thus well ensuring the directionality of resonance.

Similarly, the fourth radiator 231 and the sixth radiator 233 of the third radiation portion 23 serve as front radiators and are connected to the inner conductor of the coaxial line, and the fifth radiator 232 and the seventh radiator 234 are connected to the outer conductor of the coaxial line, and also form one feed point and three grounding points, so as to ensure the directionality of resonance.

It should be illustrated that the antennas shown in FIGS. 1 and 2 are for illustrative purposes only, and one skilled in the art may add, adjust, replace, or subtract one or more functional components from those shown in FIGS. 1 and 2 as the actual situation requires. The technical features involved in the embodiments of the antennas shown in FIGS. 1 and 2 can be combined with each other as long as they do not constitute a conflict, and can be applied independently in different embodiments as long as they do not constitute a dependency.

It could be understood by those skilled in the art that the length of the radiator, or the effective length of the radiator arm, is an important dimensional parameter in an antenna that is closely related to the frequency band at which a wireless signal is received or transmitted.

In some embodiments, the ratio of the radiator arm effective length between the first radiator 211 and the second radiator 212 corresponding to the low-frequency signal may be controlled within a preset first numerical value range.

The preset first numerical value range refers to a numerical value range formed by floating a preset numerical value up and down on the basis of 5. That is, the ratio of the radiator arm effective lengths of the first radiator 211 and the second radiator 212 can be controlled to be about 5.

The specific preset numerical value is set or determined by a skilled person according to practical situations such as experience, experimental results, or debugging results, and the preset numerical value can also be represented in any suitable form (such as by percentage). For example, on a 5 basis, it floats up and down by 1% (i.e., the preset value is 0.05).

Correspondingly, in the second radiation portion 22 corresponding to the medium frequency signal using the above-mentioned epsilon-type radiator shape” (namely, the second radiator shape), the length ratio between the third radiator 221 and the microstrip line 222 can be controlled within a preset second numerical value range.

The second numerical value range is a numerical value range formed by floating a preset numerical value up and down on the basis of 4. That is, the length ratio between the third radiator 221 and the microstrip line 222 needs to be controlled at about 4. Of course, the preset numerical value floating up and down in the second numerical value range and the preset numerical value of the first numerical value range may be different numerical values, and there is no interdependent relationship between the first numerical value range and the second numerical value range.

In other embodiments, based on the different signal frequency bands corresponding to different radiation portions, it is also necessary to control the size and length of the radiator to ensure that it meets the usage requirements of the antenna

Specifically, the size and length of the first radiator 211 (e.g., the sum of the lengths of the radiator arms and the radiator body) in the “U”-shaped radiator shape need to be controlled between ⅛ and ¾ of the low frequency resonance wavelength. The size and length of the fourth radiator 231, which also takes the U-shaped radiator shape, need to be controlled between ⅛ and ¾ of the high frequency resonance wavelength. However, the size and length of the third radiator 221 adopting the epsilon-type radiator shape need to be controlled between ⅛ and ¾ of the medium frequency resonance wavelength.

One or more embodiments of the present disclosure provides a specific example of a triple-band antenna that can operate in three frequency bands of 978 MHz, 1.09 GHz, and 5.8 GHz.

As shown in FIGS. 1 and 2, the triple-band antenna comprises: a base material 10, a first radiator 211, a second radiator 212, a third radiator 221, a microstrip line 222, a fourth radiator 231, a fifth radiator 232, a sixth radiator 233, a seventh radiator 234, a first feed line 31, a second feed line 32, a feed point 33, three grounding points (32a, 32b, 32c), and a clearance groove 40.

The first radiator 211 and the second radiator 212 both adopt a “U”-shaped radiator shape, and the total length of the first radiator 211 is ⅛ to ¾ of a low frequency (978 MHz) resonance wavelength.

The first radiator 211 serves as a rear radiator, and the second radiator 212 serves as a front radiator, constituting the first radiation portion 21. The length of the front radiator is about one-fifth of that of the rear radiator, the front radiator is connected to the inner conductor of the coaxial line (the first feed line 31), and the rear radiator is connected to the outer conductor of the coaxial line (the first feed line 31), thereby communicating with the first feed line 31 and the second feed line 32 to form one feed point and three grounding points.

The third radiator 221 and the microstrip line 222 form an epsilon-type radiator shape. The size and length of the third radiator 221 are controlled between ⅛ and ¾ of the resonance wavelength of the medium frequency (1.09 GHz), and it is connected to the outer conductor of the coaxial line (the second feed line 32). In addition, the third radiator 221 and the second radiator 212 have close frequencies and radiator arm effective lengths. The two are coupled to each other to enhance the coverage of the low and medium frequency signals.

The fourth radiator 231, the fifth radiator 232, the sixth radiator 233, and the seventh radiator 234 all have a “U”-shaped radiator shape and constitute the third radiation portion 23. A pair of clearance grooves 40 are symmetrically opened between the two arms of the sixth radiator 233.

The fourth radiator 231 and the fifth radiator 232 are in mirror symmetry and are arranged on the first surface A of the substrate 10. The fourth radiator 231 is a rear radiator, and the fifth radiator 232 is a front radiator. The size and length of the fourth radiator are controlled between ⅛ and ¾ of the high frequency (5.8 GHz) resonance wavelength. The sixth radiator 233 and the seventh radiator 234 are in mirror symmetry and are arranged on the second surface B of the substrate 10. The sixth radiator 233 is a rear radiator and the seventh radiator 234 is a front radiator.

The second feed line 32 is grounded three times, having three grounding points (32a, 32b, 32c). The front radiator is connected to the inner conductor of the coaxial line and the rear radiator is connected to the outer conductor of the coaxial line, thereby communicating with the second feed line 32, and forming one feed point and three grounding points.

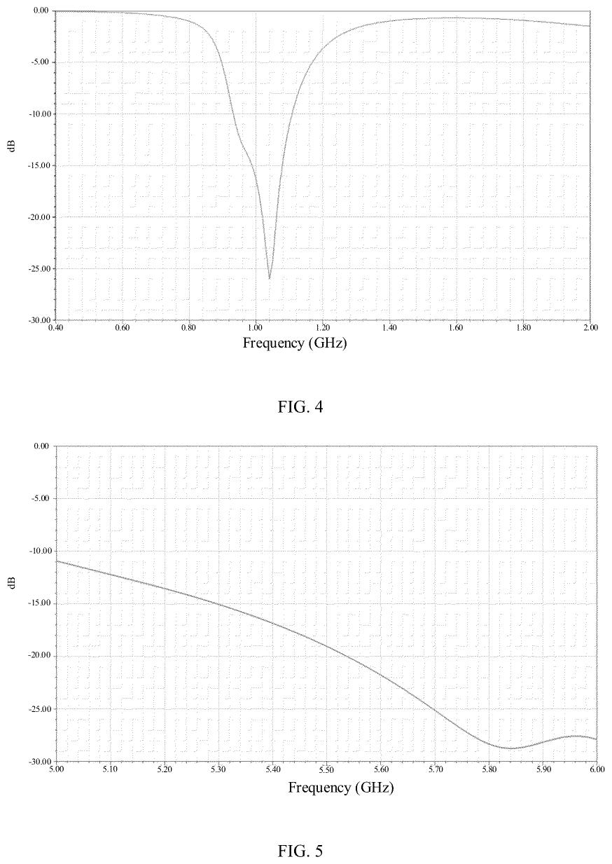

FIG. 4 is a schematic diagram of S parameters of an antenna in low and medium frequency band provided by one or more embodiments of the present disclosure. FIG. 5 is a schematic diagram of S parameters of an antenna in high frequency band provided by one or more embodiments of the present disclosure.

As shown in FIGS. 4 and 5, the antenna provided by the above embodiment can operate at 920 MHz˜1.12 MHz (low and medium frequency band) and 5.6 GHz˜6.0 GHz (high frequency band). At that, the coverage of three frequency bands of 978 MHz, 1.09 GHz, and 5.8 GHz can be achieved.

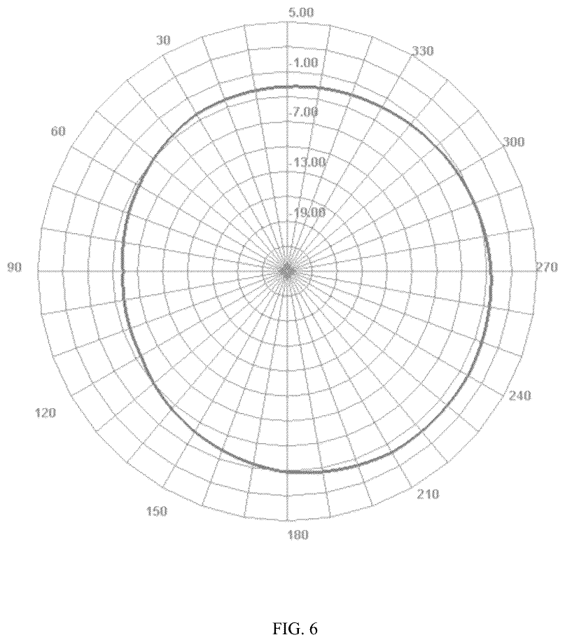

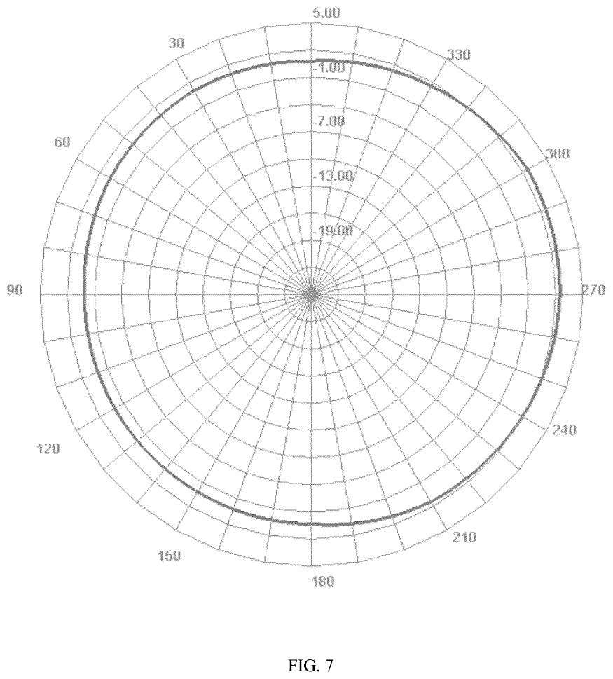

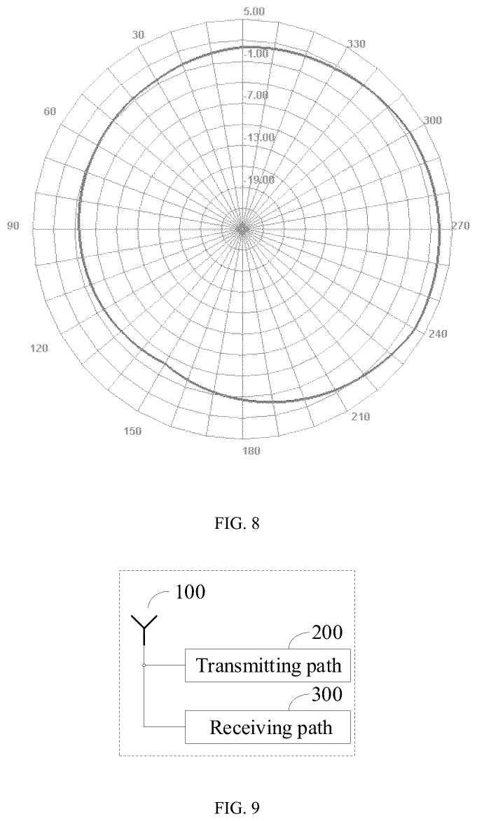

FIGS. 6 to 8 are directional diagrams of an antenna in a low frequency band, a medium frequency band, and a high frequency band, respectively, according to one or more embodiments of the present disclosure. As shown in FIGS. 6 to 8, the antenna provided by the embodiments of the present disclosure has good directivity, good omni-directivity and no defect in a specific direction in the low frequency band, the medium frequency band, and the high frequency band.

One or more embodiments of the present disclosure still further provides a wireless signal processing device based on the antenna provided in the above embodiments. The present embodiment does not limit the specific implementation of the wireless signal processing device. It can be any type or kind of electronic device used for wireless signal transmission and reception, such as a remote control, an intelligent terminal, a wearable device, or a signal transceiver for mobile vehicles.

FIG. 9 is a schematic structural diagram of a wireless signal processing device provided by one or more embodiments of the present disclosure. As shown in FIG. 9, the wireless signal processing device includes: an antenna 100, a transmitting path 200, and a receiving path 300. The antenna 100 is connected to the receiving path 200 or the transmitting path 300 through a feed line to realize signal transmission with each other.

The antenna 100 can specifically be the antenna described in one or more embodiments mentioned above, depending on the specific implementation of the wireless signal processing device. For example, the antenna 100 may be an omni-directional antenna covering three frequency bands.

The transmitting path 200 is a functional module for loading information content to be sent into a carrier signal to form a wireless signal. It can specifically be embodied in any type of electronic system that is formed by a combination of one or more electronic elements and can generate wireless signals, such as a radio frequency chip.

The receiving path 300 is an electronic system, such as a particular model of a decoding chip, for parsing the wireless signal received by the antenna to acquire the information content contained in the wireless signal. It has an opposite information flow direction to the transmitting path 200, and is a functional module for completing information acquisition.

In some embodiments, based on different specific implementations of wireless signal processing devices, one of the transmitting path 200 and the receiving path 300 can be reduced. For example, when the wireless signal processing device is a remote control, the receiving path 300 may be omitted, and only the transmitting path 200 is required to be provided.

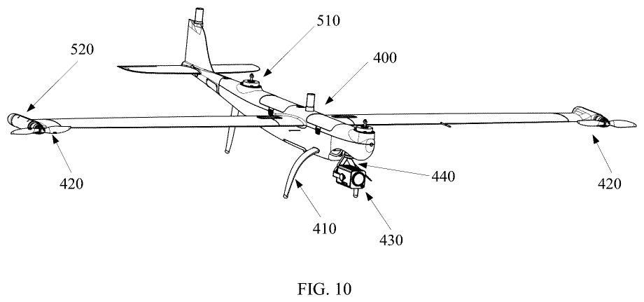

One or more embodiments of the present disclosure still further provides an application scenario for the antenna provided by the above embodiments. FIG. 10 is a schematic diagram illustrating the structure of an antenna according to one or more embodiments of the present disclosure applied to an unmanned aerial vehicle.

With the development of unmanned aerial vehicle technology, it is always desirable to reduce the fuselage volume of unmanned aerial vehicles as much as possible so that unmanned aerial vehicles can be adapted to execute flight missions in more scenarios. However, in the case of a reduced volume of the unmanned aerial vehicle fuselage, higher demands are placed on the size and structure of the antenna, which is expected to be possible in a limited volume and as simple a structure as possible.

Therefore, with the antenna provided by the embodiments of the present disclosure, the requirements of an unmanned aerial vehicle having a small fuselage with respect to the volume and structure of the antenna can be well met. As shown in FIG. 10, the unmanned aerial vehicle may include: a fuselage 400, motors (510, 520), and an antenna.

As the main structure of the unmanned aerial vehicle, the fuselage 400 may be made of any suitable material and have a structure and size suitable for use (such as a fixed wing unmanned aerial vehicle shown in FIG. 10). A variety of different functional components may be provided on the fuselage 400, such as a landing gear 410, a propeller 420, a camera 430, etc. Of course, a person skilled in the art could add or reduce one or more functional components according to the requirements of actual situations, for example, a corresponding pan-tilt 440 can be added to the camera 430.

The motors (510, 520) are mounted to the fuselage 400 for providing flight power to the unmanned aerial vehicle. One or more motors may be provided and arranged at corresponding positions of the fuselage 400 (e.g., the fuselage motor 510, the wingtip motor 520) for executing different functions (e.g., driving the rotation of the propeller 420, controlling the posture of the fuselage, etc.).

The antenna may be mounted and housed in the landing gear 410 (e.g., in the front landing gear denoted as 410 shown in FIG. 10) as part of a wireless signal transceiving device for receiving remote control operation instructions from the remote control or providing feedback on relevant data information to the remote control or other intelligent terminals (such as captured images, operating status parameters of the unmanned aerial vehicle itself).

Of course, based on the unmanned aerial vehicle application scenario provided by the above embodiments, a person skilled in the art could also apply the antenna provided by the above embodiments to other similar unpiloted mobile carriers such that it is not limited to the unmanned aerial vehicle shown in FIG. 10.

Alternatively or additionally, both the first radiator and the second radiator have a first radiator shape; and the first radiator shape comprises a radiator body provided with bending portions at two tail ends and one pair of radiator arms formed by the bending portions extending by a predetermined length.

Alternatively or additionally, the first radiator, the second radiator, and the third radiator are axial-symmetrically distributed.

Alternatively or additionally, the ratio of radiator arm effective lengths of the first radiator and the second radiator is within a preset first numerical value range; and the first numerical value range is a numerical value range formed by floating a preset numerical value up and down based on 5.

Alternatively or additionally, the second radiator is a front radiator having an opening facing a direction opposite to the direction in which the feed line extends, and the first radiator is a rear radiator having an opening facing the same direction in which the feed line extends.

Alternatively or additionally, the second radiation portion further comprises: a microstrip line; where the third radiator has a first radiator shape, and the microstrip line is a linear conductor, is arranged on an axis of symmetry of the third radiator, and forms a second radiator shape with the third radiator.

Alternatively or additionally, the length ratio of the microstrip line to the third radiator is within a preset second numerical value range; and the second numerical range is a numerical value range formed by floating a preset numerical value up and down based on 4.

Alternatively or additionally, the total length of a radiator body and a radiator arms of the first radiator is between ⅛ and ¾ of a low-frequency resonance wavelength; and a total length of a radiator body and a radiator arms of the third radiator is between ⅛ and ¾ of a medium frequency resonance wavelength.

Alternatively or additionally, the antenna further comprises: a third radiation portion symmetrically distributed over a first surface and the second surface; where the second surface is a reverse side of the first surface; where the third radiation portion comprises: a fourth radiator, a fifth radiator, a sixth radiator, and a seventh radiator; and

where the fourth radiator and the fifth radiator facing oppositely are symmetrically arranged on the first surface; and the sixth radiator and the seventh radiator facing oppositely are symmetrically arranged on the second surface.

Alternatively or additionally, the fourth radiator, the fifth radiator, the sixth radiator, and the seventh radiator all have a first radiator shape; and the first radiator shape comprises a radiator body provided with bending portions at two tail ends and one pair of radiator arms formed by the bending portions extending by a predetermined length.

Alternatively or additionally, the antenna further comprises: one pair of clearance grooves disposed on the substrate; where one pair of the clearance grooves are arranged symmetrically, and are located between radiator arms of the fourth radiator.

Alternatively or additionally, the total length of a radiator body and a radiator arms of the fourth radiator is between ⅛ and ¾ of a high-frequency resonance wavelength.

Alternatively or additionally, the fifth radiator and the seventh radiator are front radiators having openings facing a direction opposite to the direction in which the feed line extends, and the fourth radiator and the sixth radiator are rear radiators having openings facing the same direction in which the feed line extends.

Alternatively or additionally, the feed line comprises a first feed line arranged on the first surface and a second feed line arranged on the second surface; and three grounding points are disposed on the second feed line.

Alternatively or additionally, the first feed line and the second feed line are coaxial lines; and the front radiator is connected to an inner conductor of the coaxial line, and the rear radiator is connected to an outer conductor of the coaxial line, forming one feeding point and three grounding points.

Alternatively or additionally, a frequency band corresponding to the first radiation portion is 978 MHz, a frequency band corresponding to the second radiation portion is 1.09 GHz, and a frequency band corresponding to the third radiation portion is 5.8 GHz.

The antenna according to the embodiments of the present disclosure adopts reasonable wiring and structural design and can be implemented on a base material with a small volume to meet the usage requirements of a multi-band antenna. Furthermore, the radiation portions corresponding to the medium frequency band and low frequency band are coupled with each other, which can effectively enhance the low and medium frequency signals.

Finally, it should be noted that the above embodiments are merely illustrative of the technical schemes of the present disclosure, rather than limiting it; combinations of technical features in the above embodiments or in different embodiments are also possible under the concept of the disclosure, the steps can be implemented in any order, and there are many other variations of different aspects of the disclosure described above, which are not provided in detail for the sake of brevity; although the present disclosure has been described in detail with reference to the foregoing embodiments, those skilled in the art should appreciate that the technical schemes disclosed in the above-mentioned embodiments can still be amended, or some of the technical features can be replaced by equivalents; such modifications or substitutions do not make the essence of the corresponding technical scheme depart from the scope of the technical schemes of the embodiments of the disclosure.

1. An antenna, comprising:
a substrate having a flat first surface;
a first radiation portion disposed on the first surface of the substrate, the first radiation portion comprising: a first radiator and a second radiator facing in opposite directions; and
a second radiation portion disposed on the first surface of the substrate, the second radiation portion comprising: a third radiator; wherein the third radiator and the second radiator are arranged close to each other and have proximate frequencies and radiator arm effective lengths, so that the third radiator and the second radiator are coupled with each other;
wherein the first radiator, the second radiator, and the third radiator are respectively connected to form one or more feed lines.

2. The antenna according to claim 1, wherein the first radiator, the second radiator, and the third radiator are axial-symmetrically distributed.

3. The antenna according to claim 1, wherein both the first radiator and the second radiator have a first radiator shape; and
the first radiator shape comprises a radiator body provided with bending portions at two tail ends and one pair of radiator arms formed by the bending portions extending by a predetermined length.

4. The antenna according to claim 1, wherein a ratio of radiator arm effective lengths of the first radiator and the second radiator is within a preset first numerical value range; and
the first numerical value range is formed by floating a preset numerical value up and down based on 5.

5. The antenna according to claim 1, wherein the second radiator is a front radiator having an opening facing a direction opposite to a direction in which the feed line extends, and the first radiator is a rear radiator having an opening facing a same direction in which the feed line extends.

6. The antenna according to claim 2, wherein the second radiation portion further comprises: a microstrip line;
wherein the third radiator has a first radiator shape, and the microstrip line is a linear conductor, is arranged on an axis of symmetry of the third radiator, and forms a second radiator shape with the third radiator.

7. The antenna according to claim 6, wherein a length ratio of the microstrip line to the third radiator is within a preset second numerical value range; and the second numerical range is formed by floating a preset numerical value up and down based on 4.

8. The antenna according to claim 6, wherein a total length of a radiator body and a radiator arm of the first radiator is between ⅛ and ¾ of a low-frequency resonance wavelength; and a total length of a radiator body and a radiator arm of the third radiator is between ⅛ and ¾ of a medium frequency resonance wavelength.

9. The antenna according to claim 1, further comprising: a third radiation portion symmetrically distributed over a first surface and the second surface; wherein the second surface is a reverse side of the first surface;
wherein the third radiation portion comprises: a fourth radiator, a fifth radiator, a sixth radiator, and a seventh radiator; and
wherein the fourth radiator and the fifth radiator facing oppositely are symmetrically arranged on the first surface; and the sixth radiator and the seventh radiator facing oppositely are symmetrically arranged on the second surface.

10. The antenna according to claim 9, wherein the fourth radiator, the fifth radiator, the sixth radiator, and the seventh radiator all have a first radiator shape; and
the first radiator shape comprises a radiator body provided with bending portions at two tail ends and one pair of radiator arms formed by the bending portions extending by a predetermined length.

11. The antenna according to claim 10, wherein the antenna further comprises: one pair of clearance grooves disposed on the substrate;
wherein one pair of the clearance grooves are arranged symmetrically, and are located between radiator arms of the fourth radiator.

12. The antenna according to claim 10, wherein a total length of a radiator body and a radiator arm of the fourth radiator is between ⅛ and ¾ of a high-frequency resonance wavelength.

13. The antenna according to claim 10, wherein the fifth radiator and the seventh radiator are front radiators having openings facing a direction opposite to a direction in which the feed line extends, and the fourth radiator and the sixth radiator are rear radiators having openings facing a same direction in which the feed line extends.

14. The antenna according to claim 5, wherein the feed line comprises a first feed line arranged on the first surface and a second feed line arranged on the second surface; and
three grounding points are disposed on the second feed line.

15. The antenna according to claim 14, wherein the first feed line and the second feed line are coaxial lines; and the front radiator is connected to an inner conductor of the coaxial line, and the rear radiator is connected to an outer conductor of the coaxial line, forming one feeding point and three grounding points.

16. The antenna according to claim 9, wherein a first frequency band corresponding to the first radiation portion is 978 MHz, a second frequency band corresponding to the second radiation portion is 1.09 GHz, and a third frequency band corresponding to the third radiation portion is 5.8 GHz.

17. A wireless signal processing device, comprising:
an antenna for transmitting or receiving a wireless signal; and
a transmitting path for loading information content into a radio frequency carrier signal to form a wireless signal and send the wireless signal via the antenna;
wherein the antenna comprises:
a substrate having a flat first surface;
a first radiation portion disposed on the first surface of the substrate, the first radiation portion comprising: a first radiator and a second radiator facing in opposite directions; and
a second radiation portion disposed on the first surface of the substrate, the second radiation portion comprising: a third radiator; wherein the third radiator and the second radiator are arranged close to each other and have proximate frequencies and radiator arm effective lengths, so that the third radiator and the second radiator are coupled with each other;
wherein the first radiator, the second radiator, and the third radiator are respectively connected to form one or more feed lines.

18. An unmanned aerial vehicle, comprising:
a fuselage having a landing gear thereon;
a motor mounted on the fuselage for providing flight power for the unmanned aerial vehicle; and
an antenna mounted on the landing gear;
wherein the antenna comprises:
a substrate having a flat first surface;
a first radiation portion disposed on the first surface of the substrate, the first radiation portion comprising: a first radiator and a second radiator facing in opposite directions; and
a second radiation portion disposed on the first surface of the substrate, the second radiation portion comprising: a third radiator; wherein the third radiator and the second radiator are arranged close to each other and have proximate frequencies and radiator arm effective lengths, so that the third radiator and the second radiator are coupled with each other;
wherein the first radiator, the second radiator, and the third radiator are respectively connected to form one or more feed lines.
